(19) United States
(12) Patent Application Publication
(10) Pub. No.: US 2011/0064276 A1
(43) Pub. Date: Mar. 17, 2011

(54) IMAGE TRANSMISSION DEVICE AND IMAGE RECEPTION DEVICE

(75) Inventors: Nozomi TANAKA, Kyoto (JP); Shinji YAMAMOTO, Osaka (JP)

(73) Assignee: PANASONIC CORPORATION, Osaka (JP)

(21) Appl. No.: 12/948,486

(22) Filed: Nov. 17, 2010

Related U.S. Application Data
(63) Continuation of application No. PCT/JP2009/002196, filed on May 19, 2009.

(30) Foreign Application Priority Data
May 30, 2008 (JP) 2008-142391

(51) Int. Cl. G06K 9/36; G06K 9/00

(52) U.S. Cl. 382/107; 382/166

(57) ABSTRACT

In an image transmission device, an encoding unit selects a part of a plurality of color components constituting color information of inputted image data as a color component to be encoded while periodically changing the color component to be encoded to encode the image data of the selected color component to be encoded, and a data transfer unit transfers the encoded image data of the selected color component to be encoded to a data communication line. In an image reception device, when a data receiving unit receives the encoded image data of the color component to be encoded via the data communication line, a decoding unit decodes the encoded image data of the color component to be encoded, a storage unit stores therein the decoded image data of the color component to be encoded, and a combining unit combines the image data of the current color component to be encoded decoded by the decoding unit with an image data of a past color component to be encoded representing a color different to the current color component to be encoded and stored earlier in the storage unit.

### FIELD OF THE INVENTION

The present invention relates to an image transmission device and an image reception device used in a system for transmitting and receiving a moving image to and from apparatuses connected to a data communication line having a limited data transmission capacity such as network.

### BACKGROUND OF THE INVENTION

A disclosed conventional system encodes image data with a high resolution in a particular region of an image and a low resolution in any other region of the image to transmit the image data via a network having a limited bandwidth, thereby ensuring an intended image quality while reducing an information volume of the image data (for example, see the Patent Document 1).

### Prior Art Document

### Patent Document

### Patent Document 1: Unexamined Japanese Patent Applications Laid-Open No. 07-288806

### SUMMARY OF THE INVENTION

### Problem to be Solved by the Invention

In recent years, the development of image pickup devices is advancing to achieve a higher number of pixels, all the more increasing an image data volume to be handled. An advanced technique demanded under the circumstances for an apparatus which transmits image data to a network such as a network camera is to minimize the deterioration of an image quality when a moving image is transmitted to the network. When the resolution of a particular region is increased in the system disclosed in the Patent Document 1, the resolution of any other region is far lower than expected. This possibly makes the image quality too poor, and contents of the image reproduced in a reception apparatus may not be visually determined in some regions.

### Means for Solving the Problem

An image transmission device according to the present invention comprises:
an image obtaining unit for obtaining an image data inputted from outside;
an encoding unit for selecting, as a color component to be encoded, a part of a plurality of color components constituting a color information of the image data obtained by the image obtaining unit while periodically changing the color component to be encoded to encode the image data of the selected color component to be encoded; and
a data transfer unit for transferring the image data of the selected color component encoded by the encoding unit to a data communication line.

An image reception device according to the present invention comprises:
a data receiving unit for receiving an encoded image data of a color component to be encoded via a data communication line, the color component to be encoded being a part of a plurality of color components constituting a color information of the image data and selected therefrom through periodical changes;
a decoding unit for decoding the encoded image data of the color component to be encoded received by the data receiving unit;
a storage unit for storing therein the encoded image data of the color component to be encoded decoded by the decoding unit; and
a combining unit for combining the image data of the current color component to be encoded decoded by the decoding unit with an image data of a past color component to be encoded representing a color different to the current color component to be encoded and decoded earlier and already stored in the storage unit.

According to the present invention, the encoding unit of the data transmission device selects the color component to be encoded from the plurality of color components in the inputted image data while periodically changing the color component to be encoded, and encodes the image data of the selected color component using a predefined encoding method and sends the encoded image data to the data transfer unit. The data transfer unit transfers the encoded image data of the color component to be encoded to the image reception device via the data communication line. The encoding unit of the image reception device repeatedly encodes the image data while periodically changing the color component to be encoded. According to the present invention, only a part of the color components of the inputted image data are chosen as the color component to be encoded by the encoding unit and the color component to be transferred by the data transfer unit. Therefore, an information volume of the image data to be processed is lessened, and an encoding rate is accordingly controlled. As a result, the present invention can transmit the image data with less deterioration of its image quality via the data communication line having a limited data transmission capacity.

Another technical characteristic of the image reception device according to the present invention is for the combining unit to combine the image data of the current color component to be encoded decoded by the decoding unit with the image data of the past color component to be encoded different to the current color component and decoded earlier and already stored in the storage unit, so that the image is reproduced. According to these technical features of the storage unit and the combining unit, the image reception device can reproduce the original image data with less deterioration of its image quality even if the image data transmitted through the data communication line represents only a part of a plurality of color components in the inputted image data.

According to an exemplary mode of the present invention, the encoding unit of the image transmission device encodes the image data while periodically changing the color component to be encoded in the order of Y component, UV component, Y component, UV component per frame, or in the order of Y component, UV component, Y component, UV component per frame.

According to another preferred mode of the present invention, the image transmission device further comprises a division pattern setting unit for setting a color component division pattern indicating setting of change of the color component to be encoded, wherein
the encoding unit selects the color component to be encoded from the plurality of color components while periodically changing the color component to be encoded in accordance with the color component division pattern set by the division pattern setting unit and then encodes the image data of the selected color component to be encoded, and
the data transfer unit appends the color component division pattern set by the division pattern setting unit to the encoded image data of the selected color component to be encoded and transfers the resulting encoded image data to the data communication line.

It is preferable in the another preferred mode that the data transfer unit measure a communication load of the data communication line, and the division pattern setting unit set the color component division pattern depending on the communication load measured by the data transfer unit.

According to the another preferred mode, the division pattern setting unit is able to arbitrarily set the color component division pattern depending on changing congestion situation of the data communication line. Thus, the image data can be transmitted with less deterioration of its image quality irrespective of how busy the data communication line is.

According to still another preferred mode of the present invention, the image transmission device further comprises a motion detecting unit for detecting a quantity of image motion in the inputted image data, wherein
the encoding unit encodes all of the color components constituting the image data when the encoding unit determines that the quantity of image motion detected by the motion detecting unit is greater than a given threshold value.

Possible degradation of the image quality due to lower resolution is visually not a noticeable disadvantage in any image moving very fast. Therefore, the image data of all of the color components are encoded in place of selecting the color component to be encoded when the quantity of image motion is greater than the threshold value. As a result, an image processing speed can be improved.

According to still another preferred mode of the present invention, the image transmission device further comprises a motion detecting unit for detecting a quantity of image motion in the inputted image data, wherein
the encoding unit changes the color component to be encoded per frame,
the motion detecting unit detects a quantity of motion of a color component different to the color component to be encoded, and
the data transfer unit further transfers the quantity of motion of the color component different to the color component to be encoded to the data communication line.

When the data transfer unit thus transfers the encoded data of the color component to be encoded and the quantity of motion of the color component different to the color component to be encoded to the data communication line, the image reception device can perform a motion compensation to the image data of the past color component to be encoded depending on the quantity of image motion.

According to still another preferred mode of the present invention, the image reception device comprises, to deal with the image transmission device according to the mode described earlier, a motion compensating unit, a smoothening unit, and a combining unit, wherein
the data receiving unit further receives a quantity of motion of a color component different to the color component to be encoded,
the motion compensating unit performs a motion compensation to the past image data stored in the storage unit using the quantity of motion of the color component newly received,
the smoothening unit smoothens the past image data stored in the storage unit and the image data of the color component to be encoded newly received and decoded by the decoding unit depending on the quantity of motion of the color component newly received, and
the combining unit combines the image data of the color component to be encoded newly received by the data receiving unit and smoothened by the smoothening unit and then decoded by the decoding unit with the past image data motion-compensated by the motion compensating unit.

Due to a time lag generated between the image data of the current color component to be encoded and the image data of the past color component to be encoded, there may be color drift in a moving photographic subject. The motion compensating unit and the smoothening unit are provided to alleviate the color drift.

### Effect of the Invention

According to the present invention wherein only a part of the color components are chosen from the image data to be encoded and transmitted when the image signal is transmitted through the data communication line such as network, the volume of information to be encoded can be lessened, and the encoding rate is thereby controlled. This technical advantage can transmit an image with less deterioration of its image quality.

### BRIEF DESCRIPTION OF THE DRAWINGS

FIG. 1 is a block diagram illustrating an overall structure of an image communication apparatus according to an exemplary embodiment 1 of the present invention.

FIG. 2 is an illustration of an operation according to the exemplary embodiment 1 in which image data is divided into Y components, U components, and V components, transmitted and received in the order of Y, U, V.

FIG. 3 is an illustration of an operation according to the exemplary embodiment 1 in which image data is divided into Y components, U components, and V components, and transmitted and received in the order of Y, U, Y, V.

FIG. 4 is an illustration of an operation according to the exemplary embodiment 1 in which image data is divided into Y components and UV components, and transmitted and received in the order of Y, UV.

FIG. 5 is an illustration of an operation according to the exemplary embodiment 1 in which image data is divided into R components, G components, and B components, and transmitted and received in the order of R, G, B.

FIG. 6 is a block diagram illustrating an overall structure of an image communication apparatus according to an exemplary embodiment 2 of the present invention.

FIG. 7 is a block diagram illustrating an overall structure of an image communication apparatus according to an exemplary embodiment 3 of the present invention.

FIG. 8 is a block diagram illustrating an overall structure of an image communication apparatus according to an exemplary embodiment 4 of the present invention.

FIG. 9 illustrates a motion vector and a predicted error according to the exemplary embodiment 4.

### BEST MODE FOR CARRYING OUT THE INVENTION

Hereinafter, exemplary embodiments of the present invention are described in detail referring to the drawings. The exemplary embodiments described below are just a few examples and can be variously modified.

### Exemplary Embodiment 1

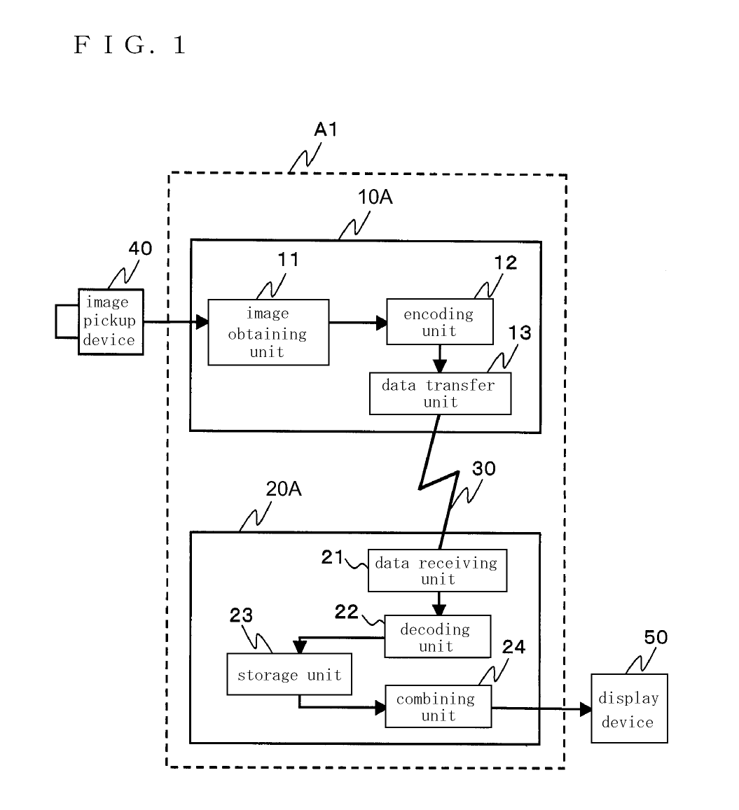

FIG. 1 is a block diagram illustrating an overall structure of an image communication apparatus A1 according to an exemplary embodiment 1 of the present invention. The present exemplary embodiment provides a system for transmitting an image having a sizable data volume via a data communication line having a limited data transmission capacity such as network. The present exemplary embodiment is not necessarily limited to the network but can be applied to a variety of data communication lines which interconnects an image transmission device and an image reception device.

The present exemplary embodiment is technically characterized in that an image data of a part of a plurality of color components constituting a color information of the image data is transmitted in one frame as a color component to be encoded, so that the current color component to be encoded received on reception side is combined with an image data of a past color component to be encoded (representing a color different to the current color component to be encoded). This technical advantage can reduce an information volume of the image data and controls an image encoding rate, thereby transmitting an image with less deterioration of its image quality.

The image communication apparatus Al has an image transmission device 10A, an image reception device 20A, and a network 30. The network 30 transmits data to and from the mage transmission device 10A and the image reception device 20A. An image pickup device 40 is connected to the image transmission device 10A, and a display device 50 is connected to the image reception device 20A. Apart from the image pickup device 40, a device which outputs image data can be connected to the image transmission device 10A.

The image transmission device 10A has an image obtaining unit 11, an encoding unit 12, and a data transfer unit 13. The image obtaining unit 11 fetches an image data inputted from the image pickup device 40 into a memory. The image obtaining unit 11 can handle the inputted image data in the format of YUV or RGB. YUV represents a luminance/color difference multiplex signal, Y represents a luminance signal, U represents a red color difference signal, and V represents a blue color difference signal.

The encoding unit 12;
reads the image data from the memory of the image obtaining unit 11,
selects whenever necessary a part of a plurality of color components constituting a color information of the read image data as a color component to be encoded,
encodes the image data of the selected color component to be encoded using a conventional image compression algorithm such as prediction encoding, orthogonal encoding or vector quantization, and
outputs the resulting image data of the color component to be encoded to the data transfer unit 13.

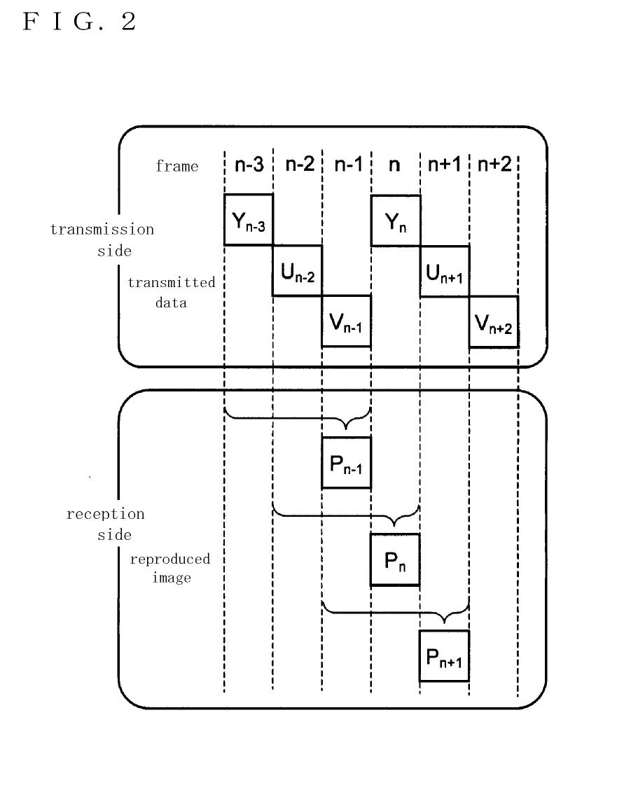

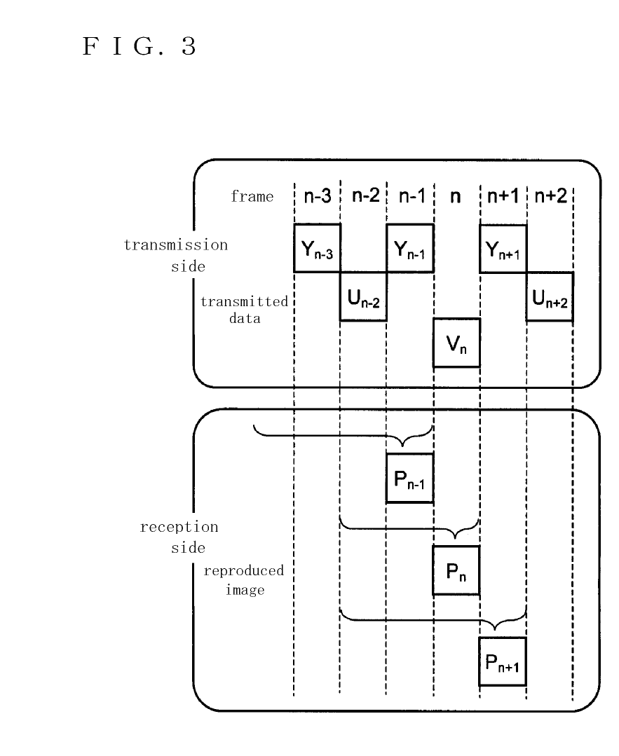

The selection of the color component to be encoded follows a color component division pattern. The information of color component division pattern indicates which of a plurality of color component division patterns including, for example, a color component division pattern illustrated in FIG. 2 and a color component division pattern illustrated in FIG. 3 is used to transmit and receive the image data. The color component division pattern is set in advance in a storage device such as ROM. In the technical structure described so far, the color component to be encoded is periodically changed in accordance with the color component division pattern.

The data transfer unit 13 transmits the image data of the color component to be encoded to the network 30.

The image reception device 20A has a data receiving unit 21, a decoding unit 22, a storage unit 23, and a combining unit 24. The data reception unit 21 receives the encoded data of the color component to be encoded from the network 30 and outputs the received encoded data to the decoding unit 22. The decoding unit 22 decodes the encoded data of the color component to be encoded and outputs the decoded data to the storage unit 23. The combining unit 24 combines the image data of the current color component to be encoded decoded by the decoding unit 22 with the image data of the past color component to be encoded representing a color different to the current image data and read from the storage unit 23 to thereby restore an image. The combining unit 24 implements the image decoding process described so far in accordance with the preset color component division pattern.

The image decoding process carried out by the combining unit 24 is described referring to FIG. 2 based on an example in which the inputted image data has YUV format, and the color components of the inputted image data are divided into Y components, U components, and V components and transmitted in the order of Y, U, V, Y, U, V.

In the description given below, for example, the image obtaining unit 11 of the image transmission device 10A obtains the image data of nth frame.

[Processing in nth Frame]

Upon the reception of the image data of nth frame, the encoding unit 12 encodes a Y component Yₙ of the inputted image data in nth frame as the color component to be encoded and outputs an encoding result thereby obtained to the data transfer unit 13. The data transfer unit 13 transmits the encoded data of the color component to be encoded to the network 30. The decoding unit 22 of the image reception device 20A receives the encoded data of the Y component Yₙ of the inputted image data in nth frame and decodes the received encoded data, and then stores a decoding result thereby obtained in the storage unit 23.

The combining unit 24 combines;
Y component Yₙ which is the color component to be encoded of current nth frame received and stored in the storage unit 23,
V component Vₙ₋₁ which is the color component to be encoded of (n−1)th frame received immediately before the current frame, and
U component Vₙ₋₂ which is a color component to be encoded of (n−2)th frame received two frames before the current frame.

Then, the combining unit 24 reproduces the image data thus combined as a reproduction image Pₙ of nth frame.

[Processing in (n+1)th Frame]

Upon the reception of the image data of (n−1)th frame, the combining unit 24 combines;
V component Vₙ₋₁ which is the color component to be encoded of (n−1)th frame,
Y component Yₙ which is the color component to be encoded of nth frame
U component Uₙ₊₁ which is the color component to be encoded of (n+1)th frame.

Then, the combining unit 24 reproduces the image data thus combined as a reproduction image Pₙ₊₁ of (n+1)th frame.

The image transmission device 10A and the image reception device 20A repeatedly process the image data as described above while changing the encoding color component to be updated.

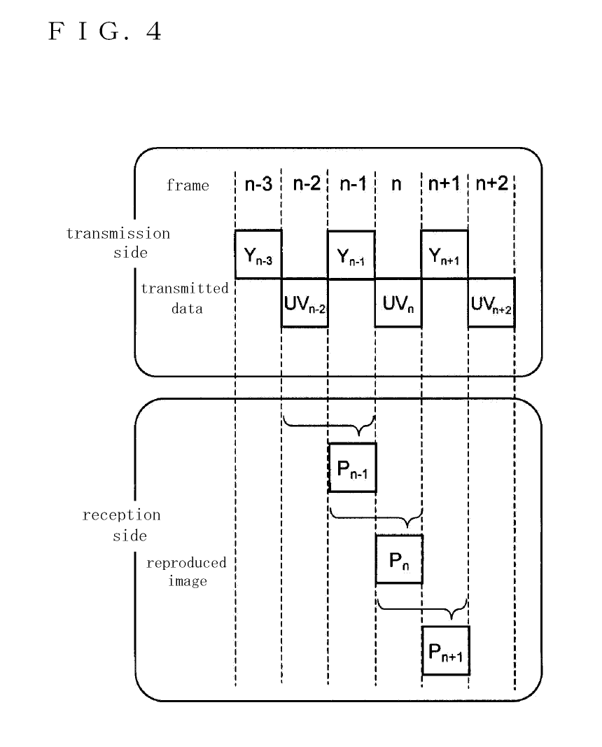

To transmit the image data, the color components of the image data may be divided into different groups as illustrated in FIGS. 3 and 4. In the example illustrated in FIG. 3, the color components of the image data are divided into Y components, U components, and V components, and the color components to be encoded are changed in the order of Y, U, Y, V, Y, U, Y, V during the image data transmission.

In (n−2)th frame, the encoded data of U component Uₙ₋₂ in the inputted image data is transmitted as the color component to be encoded. In (n−1)th frame, the encoded data of Y component Yₙ₋₁ in the inputted image data is transmitted as the color component to be encoded.

The decoding unit 22 decodes;
encoded data of U component Uₙ₋₂ which is the color component to be encoded of (n−2)th frame stored in the storage unit 23, and
encoded data of U component Yₙ₋₁ which is the color component to be encoded of (n−1)th frame.

The combining unit combines;
U component Uₙ₋₂ and Y component Yₙ₋₁ which are the image data of the color components to be encoded in (n−2)th frame and (n−1)th frame decoded by the decoding unit 22,
reproduced image data of nth frame, and
V component Vₙ of the inputted image data received in the current frame.

The combining unit 24 then outputs the image data thus combined to the display device 50, so that the image data is reproduced thereon as a reproduction image Pₙ.
In (n+1)th frame, the encoded data of Y component Yₙ₊₁ in the inputted image data is updated by the decoding unit 22.

The combining unit 24 combines,
Y component Yₙ₊₁ of the inputted image data in (n+1)th frame,
V component Vₙ of the inputted image data in nth frame, and
U component Uₙ₊₂ of the inputted image data in (n−2)th frame.

The combining unit 24 then outputs the image data thus combined to the display device 50, so that the image data is reproduced thereon.

In the example illustrated in FIG. 4, the color components of the image data are divided into Y components and UV components, and these components are transmitted in turn.

[Processing in nth Frame]

The data transfer unit 13 of the image transmission device 10A transmits the encoded data of UV component UVₙ of the inputted image data (color component to be encoded in nth frame) to the network 30. The combining unit 24 of the image reception device 20A combines Y component Yₙ₋₁ of the image data received in (n−1)th frame and stored in the storage unit 23 (color component to be encoded in (n−1)th frame) with UV component UVₙ of the image data received in the current frame (color component to be encoded in nth frame), and reproduces an image obtained from the combined image data.

[Processing in (n+1)th Frame]

The data transfer unit 13 of the image transmission device 10A transmits the encoded data of Y component Yₙ₊₁ of the inputted image data (color component to be encoded in (n+1)th frame) to the network 30. The combining unit 24 of the image reception device 20A combines UV component UVₙ of the image data received in nth frame (color component to be encoded in nth frame) with Y component Yₙ₊₁ of the image data received in the current frame (color component to be encoded in (n+1)th frame), and reproduces an image obtained from the combined image data.

The combining unit 24 reproduces the image data, and outputs the post-reproduction image data to the display device 50. The combining unit 24 thereafter repeatedly updates the Y components and the UV components in turn.

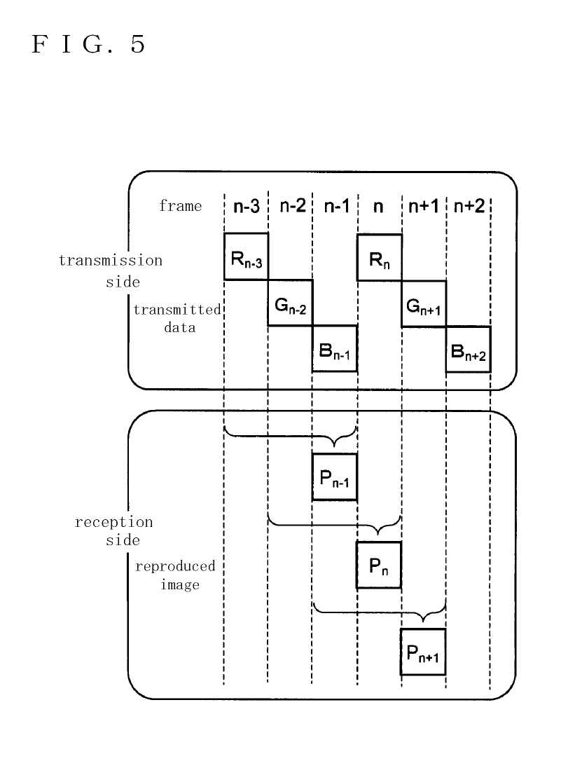

There are many other different methods for dividing and combining the color components other than the example described so far, for example, the YU components and YV components of the image data are transmitted in turn every other frame. The signal of YUV format is not necessarily limited to YUV444. Such formats as YUV422, YUV420, and YUV 411 can further lessen the information volume. An image of RGB format can be inputted to the image obtaining unit 11, and the image obtaining unit 11 may be equipped with a function to convert YUV format into RGB format so that the image data can be divided into R, G, and B components and then transmitted as illustrated in FIG. 5.

As described so far, according to the present exemplary embodiment, the encoding unit 12 fetches a part of the plurality of color components in the inputted image data in one frame as the color component to be encoded and encodes the image data of the fetched color component to be encoded, and the data transfer unit 13 transfers the encoded data to the image reception device 20A. As a result, the information volume of the image data to be processed is lessened, and the encoding rate is thereby controlled. This technical advantage can transmit the image data with less deterioration of its image quality in the case where the network 30 has a limited transmission capacity. Further, the image reception device 20A according to the present exemplary embodiment can combine the image data of the current color component to be encoded newly received with the image data of the past color component to be encoded. The image reception device 20A thus technically advantageous can reproduce the image data with less deterioration of its image quality.

### Exemplary Embodiment 2

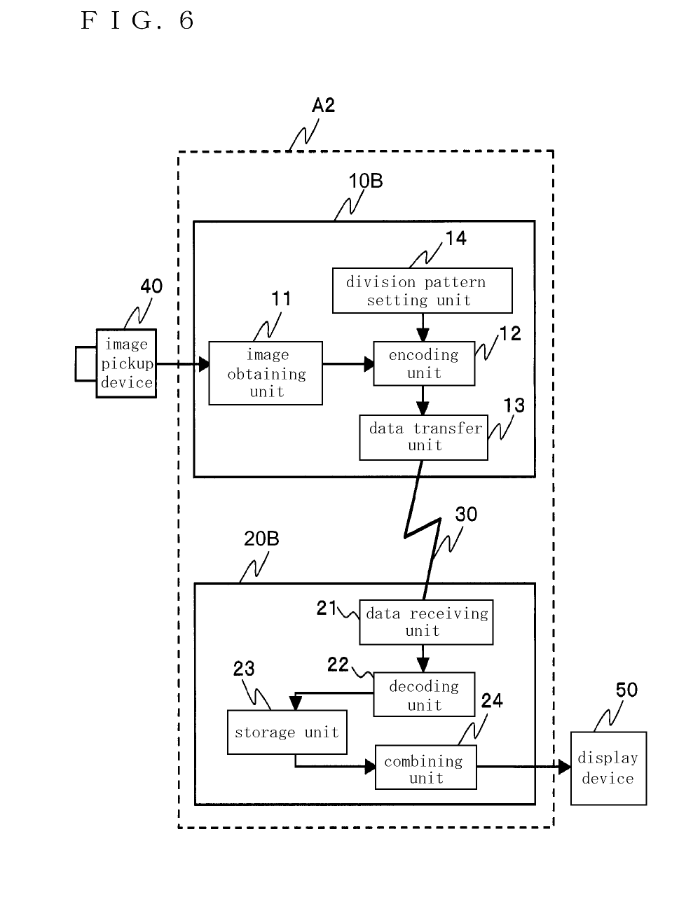

FIG. 6 is a block diagram illustrating an overall structure of an image communication apparatus A2 according to an exemplary embodiment 2 of the present invention. In FIG. 6, the same reference symbols as those illustrated in FIG. 1 according to the exemplary embodiment 1 denote the same structural elements, and description of these structural elements will be omitted. In the image communication apparatus A2, an image transmission device 10B is further provided with a division pattern setting unit 14. The division pattern setting unit 14 has a changeable storage device such as register, and the storage device stores therein an inputted image data format and information of color component division pattern and. In a manner similar to the exemplary embodiment 1, the information of color component division pattern indicates which of a plurality of color component division patterns including the color component division pattern illustrated in FIG. 2 and the color component division pattern illustrated in FIG. 3 is used to transmit and receive the image data.

Similarly to the exemplary embodiment 1, the encoding unit 12 of the image transmission device 10B;
reads the image data from the memory of the image obtaining unit 11,
selects whenever necessary a part of a plurality of color components constituting a color information of the read image data as a color component to be encoded,
encodes the image data of the selected color component to be encoded using a conventional image compression algorithm such as prediction encoding, orthogonal encoding or vector quantization, and
outputs the resulting image data of the color component to be encoded to the data transfer unit 13.

The data transfer unit 13 appends the information of color component division pattern to the inputted encoded data and transmits the resulting encoded data to the network 30.

In an image reception device 20B, the data receiving unit 21 receives the encoded data of the color component to be encoded from the network 30, and outputs the received encoded data to the decoding unit 22. The decoding unit 22 decodes the encoded data of the color component to be encoded and outputs the decoded data to the storage unit 23. The combining unit 24 reads the image data of the current color component to be encoded decoded by the decoding unit 22 and the image data of the past color component to be encoded previously stored in the storage unit 23 (representing a color different to the current color component to be encoded) from the storage unit 23 and combines these image data to restore an image. The combining unit 24 implements the image decoding process described so far in accordance with the information of color component division pattern transmitted from the image transmission device 10B along with the image data. The transmission and reproduction of the image data are carried out in a manner similar to the exemplary embodiment 1, therefore, description of these operations is omitted.

As described so far, according to the present exemplary embodiment, the division pattern setting unit 14 can set the color component division pattern depending on changing congestion situation of the network 30. This technical advantage can transmit the image data with less deterioration of its image quality irrespective of how busy the network 30 is.

The data transfer unit 13 may be equipped with a function to measure the traffic of the network 30, wherein the division pattern setting unit 14 can automatically change the color component division pattern depending on the communication load of the network 30. In the suggested structure, all of the color components of the image data in one frame are transmitted when the communication load of the network 30 is not particularly heavy, and a part of the color components is selected as the color component to be encoded and the image data of the selected color component to be encoded alone is transmitted when the network 30 is very busy. As a result, the data volume of the image data to be transmitted can be increased or decreased depending on how busy the network 30 is.

### Exemplary Embodiment 3

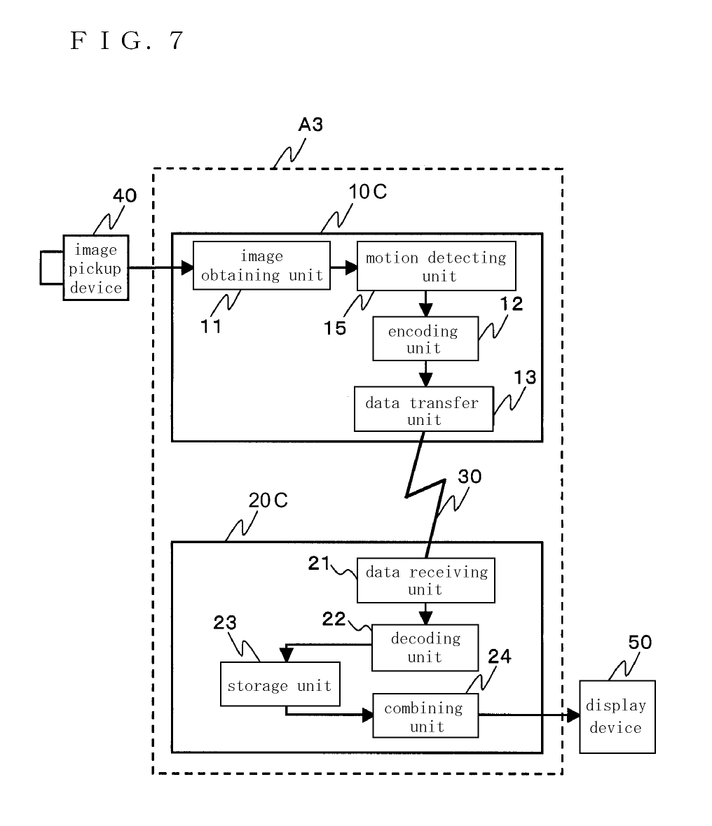

FIG. 7 is a block diagram illustrating an overall structure of an image communication apparatus A3 according to an exemplary embodiment 3 of the present invention. In FIG. 7, the same reference symbols as those illustrated in FIG. 1 according to the exemplary embodiment 1 denote the same structural elements, and description of these structural elements will be omitted. In the image communication apparatus A3, an image transmission device 10C is further provided with a motion detecting unit 15. The inputted image data of a frame previous to the current frame is stored in the memory provided in the image obtaining unit 11, and the motion detecting unit 15 then detects a quantity of image motion is detected from a difference between the inputted image data in the current frame and the inputted image data in the previous frame. A storage device of the motion detecting unit 15 stores therein a threshold value based on which the color component division pattern of the image data is selected. In a storage device of the encoding unit 12 such as ROM, the color component division pattern is stored in advance.

The encoding unit 12 compares the quantity of image motion detected by the motion detecting unit 15 to the threshold value. When a comparison result thereby obtained says that the motion quantity is at most the threshold value, the encoding unit 12, in a manner similar to the exemplary embodiment 1;
selects whenever necessary a part of a plurality of color components constituting a color information of the read image data as a color component to be encoded in accordance with the color component division pattern previously set,
encodes the image data of the selected color component to be encoded using a conventional image compression algorithm such as prediction encoding, orthogonal encoding or vector quantization, and
outputs the encoded image data to the data transfer unit 13.

When it is known from the comparison result that the motion quantity is greater than the threshold value, the encoding unit 12 does not divide the color components of the image data but encodes the image data of all of the color components to be encoded in one frame.

The data transfer unit 13 appends the information of color component division pattern to the encoded data and transmits the resulting encoded data to the network 30.

In an image reception device 20C, the data receiving unit 21 receives the encoded data of the color component to be encoded from the network 30, and outputs the received encoded data to the decoding unit 22. The decoding unit 22 decodes the encoded data of the color component to be encoded and outputs the decoded data to the storage unit 23. The combining unit 24 determines whether or not the color components were divided in the encoded data received from the network 30. When the combining unit 24 determines that the color components were divided in the received encoded data, the combining unit 24, in a manner similar to the exemplary embodiment 1, reads the image data of the current color component to be encoded decoded by the decoding unit 22 and the image data of the past color component to be encoded previously stored in the storage unit 23 (representing a color different to the current color component to be encoded) from the storage unit 23 and combines these image data to restore an image. The combining unit 24 implements the image decoding process described so far in accordance with the information of color component division pattern defined in advance. When it is determined that the encoded data received from the network 30 does not include the divided color components but includes all of the color components, the combining unit 24 directly outputs the image data decoded by the decoding unit 22 to the display device 50.

The image transmission device 10C may be provided with a division pattern setting unit configured similarly to that of the exemplary embodiment 2 to preset two color component division patterns, so that one of the two color component division patterns is selected based on a threshold value given to select the color component division patterns.

As described so far, according to the present exemplary embodiment, the motion detecting unit 15 detects the speed of the image motion, and the image data of all of the color components is encoded in place of selecting the color component to be encoded when the detected quantity of image motion is greater than the threshold value. This technical feature can be effective because any image moving fast has a poor image quality due to low resolution but the poor image quality is visually not a noticeable disadvantage. As a result, an image processing speed can be improved.

### Exemplary Embodiment 4

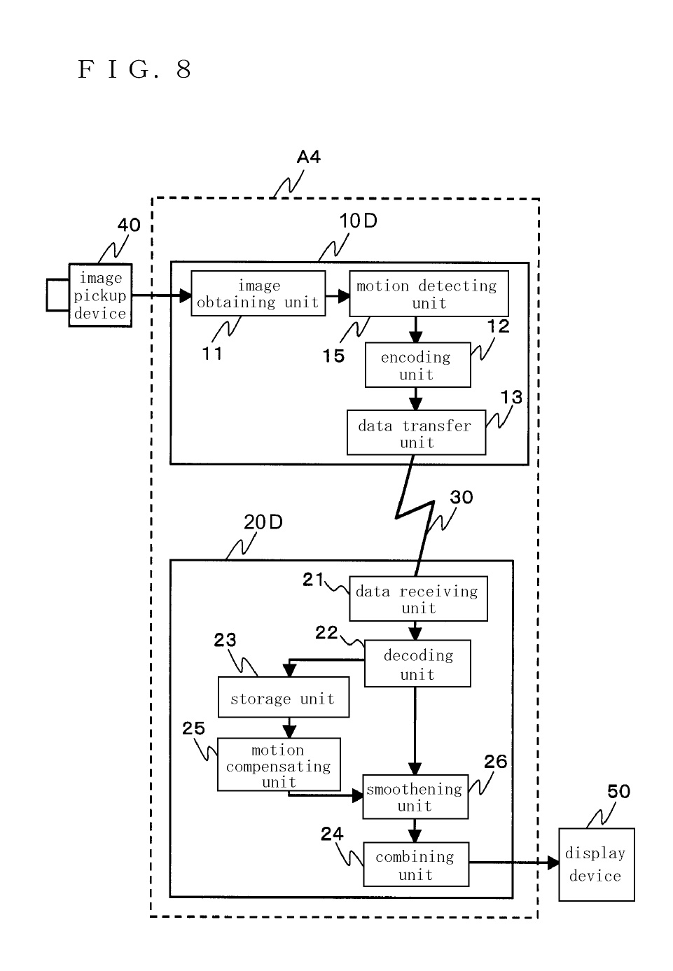

FIG. 8 is a block diagram illustrating an overall structure of an image communication apparatus A4 according to an exemplary embodiment 4 of the present invention. In FIG. 8, the same reference symbols as those illustrated in FIG. 7 according to the exemplary embodiment 3 denote the same structural elements, and description of these structural elements will be omitted. In an image reception device 20D of the image communication apparatus A4, the combining unit 24 reads the image data of the current color component to be encoded decoded by the decoding unit 22 and stored in the storage unit 23 and the image data of the past color component to be encoded decoded earlier and stored in the storage unit 23 (representing a color different to the current color component to be encoded) from the storage unit 23 in accordance with the preset color component division pattern, and combines these image data to restore an image. When the image data are thus combined, the image data of a moving photographic subject possibly undergoes color drift due to a time lag generated between the image data of the color component to be encoded in the current frame and the image data of the color component to be encoded in the past frame. The present exemplary embodiment alleviates the color drift.

The image reception device 20D of the image communication apparatus A4 is further equipped with a motion compensating unit 25 and a smoothening unit 26. The motion compensating unit 25 performs a motion compensation to the image data of the color component to be encoded in the past frame stored in the storage unit 23 using a predicted error and a motion vector transmitted from the image transmission device 10D along with the image data of the color component to be encoded in the current frame, and then outputs the motion-compensated image data to the smoothening unit 26. The predicted error and the motion vector are calculated by the motion detecting unit 15 in the image transmission device 10D, and transmitted by the data transfer unit 13 to the image reception device 20D via the network 30. The smoothening unit 26 blurs the image data depending on the quantity of image motion transmitted along with the image data of the color component to be encoded. The smoothening unit 26 uses a smoothening filter and moving average method to blur the image data.

The motion detecting unit 15 of the image transmission device 10D detects the motion vector between the inputted image data and the image data in a frame previous to the current frame, and creates the predicted image based on the motion vector of the image data in the previous frame. Then, the motion detecting unit 15 appends the predicted image of the color component which is not transmitted in the current frame, predicted error which is a difference between the inputted images, and motion vector to the image data of the color component to be encoded in the current frame along with the quantity of image motion, and transmits the resulting image data.

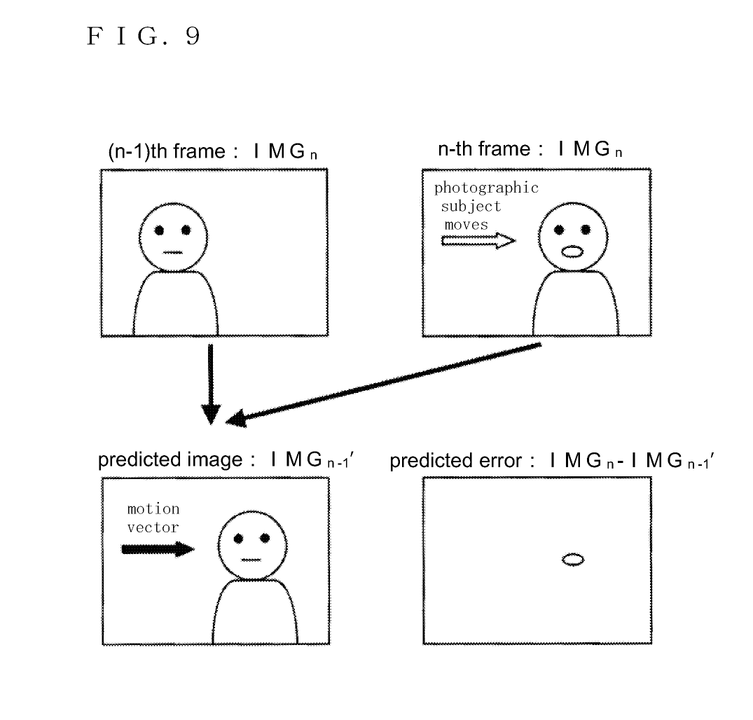

The motion vector is more specifically described. When the inputted image data is divided into m×n blocks, and the block which is most similar (hereinafter, called similar block) to the block to be encoded (hereinafter, called block to be encoded) is detected from the predicted image, the motion vector is generated between the block to be encoded and the similar block. FIG. 9 is a schematic drawing of the predicted error and the motion vector.

The data transfer unit 13 appends the predicted error, motion vector, and quantity of image motion, which are calculated by the motion detecting unit 15 when the encoded image data is transmitted to the network 30, to the image data, and then transmits the resulting image data.

The operation is more specifically described based on an example in which the image data is divided into Y components, U components, and V components, and Y component Yₙ of the image data in nth frame is transmitted. In the given example, the motion detecting unit 15 calculates;
the predicted error and the motion vector from V component Vₙ of the image data in nth frame and V component Vₙ₋₁ of the image data in (n−1)th frame, and
the predicted error and the motion vector from the U component Uₙ of the image data in nth frame and a predicted image Uₙ₋₁′ of U component in (n−1)th frame.

Then, the data transfer unit 13 appends the predicted errors and the motion vectors calculated by the motion detecting unit 15 to the image data to be transmitted. The predicted image Uₙ₋₁′ is created from U component Uₙ₋₁ of the image data in (n−1)th frame and U component Uₙ₋₂ of the image data in (n−2)th frame.

The motion compensating unit 25 of the image reception device 20D which received these image data performs the motion compensation to V component Vₙ₋₁ which is the image data of the color component to be encoded in (n−1)th frame and U component Uₙ₋₂ which is the image data of the color component to be encoded in (n−2)th frame using the predicted errors and the motion vectors transmitted along with the image data of the color component to be encoded in the current frame (nth frame).

The smoothening unit 26 smoothens the following components depending on the quantity of image motion received along with the image data;
V component Vₙ₋₁ which is the image data of the motion-compensated color component to be encoded in (n−1)th frame,
U component Uₙ₋₂ which is the image data of the motion-compensated color component to be encoded in (n−2)th frame, and
Y component Yₙ which is the image data of the color component to be encoded in the current frame (nth frame).

The combining unit 24 combines the following components and reproduces an image from the combined image data;
Y component Yₙ which is the image data of the smoothened color component to be encoded in the current frame (nth frame),
V component Vₙ₋₁ which is the image data of the motion-compensated/smoothened color component to be encoded in (n−1)th frame, and
U component Uₙ₋₂ which is the image data of the motion-compensated/smoothened color component to be encoded in (n−2)th frame.

The human eyesight is relatively poor for any moving object. Therefore, when the image data of the color components to be encoded in the past and current frames are blurred and then combined by the combining unit 24, the color drift due to any time lag between the color components to be encoded can be lessened.

Another way to smoothen the color components is to divide image data into m×n blocks using the motion detecting unit 15 to detect the quantity of motion by each of the blocks, and transmit the image data with the detected quantity of motion appended thereto so that the color components are smoothened by the smoothening unit 26 by each of the m×n blocks depending on the quantity of motion. The suggested technique can reproduce an image more natural to the eye as far as a suitable number of blocks having a right size are determined because the information volume is increased as the blocks are smaller.

To prevent such an unfavorable event that only a part of the image is blurred when the image data is smoothened depending on the quantity of motion by each block, the whole image data may be smoothened based on the block having a largest quantity of motion. It is also effective to reduce colorfulness of the color components in the case of a large quantity of motion so that the color drift is inconspicuous.

The image transmission device 10D may be provided with the division pattern setting unit, wherein the image data is encoded in accordance with the preset color component division pattern, and the information of color component division pattern is transmitted from the data transfer unit 13 along with the image data and the quantity of motion.

### INDUSTRIAL APPLICABILITY

The technology provided by the present invention is advantageously utilized in an image transmission device which transmits image data with less deterioration of its image quality and an image reception device which reproduces the original image data with less deterioration of its image quality in a system for transmitting and receiving a moving image via a data communication line having a limited transmission capacity such as network.

### DESCRIPTION OF REFERENCE SYMBOLS

A1-A4 image communication apparatus
10A-10D image transmission device
11 image obtaining unit
12 encoding unit
13 data transfer unit
14 division pattern setting unit
15 motion detecting unit
20A-20D image reception device
21 data receiving unit
22 decoding unit
23 storage unit
24 combining unit
25 motion compensating unit
26 smoothening unit
30 network
40 image pickup device
50 display device

What is claimed is:

1. An image transmission device comprising:
an image obtaining unit for obtaining an image data inputted from outside;
an encoding unit for selecting, as a color component to be encoded, a part of a plurality of color components constituting a color information of the image data obtained by the image obtaining unit while periodically changing the color component to be encoded to encode the image data of the selected color component to be encoded; and
a data transfer unit for transferring the image data of the selected color component encoded by the encoding unit to a data communication line.

2. An image reception device comprising:
a data receiving unit for receiving an encoded image data of a color component to be encoded via a data communication line, the color component to be encoded being a part of a plurality of color components constituting a color information of the image data and selected therefrom through periodical changes;
a decoding unit for decoding the encoded image data of the color component to be encoded received by the data receiving unit;
a storage unit for storing therein the encoded image data of the color component to be encoded decoded by the decoding unit; and
a combining unit for combining the image data of the current color component to be encoded decoded by the decoding unit with an image data of a past color component to be encoded representing a color different to the current color component to be encoded and decoded earlier and already stored in the storage unit.

3. The image transmission device as claimed in claim 1, wherein
the encoding unit encodes the image data while periodically changing the color component to be encoded in the order of Y component, U component, Y component, V component, Y component, U component per frame.

4. The image transmission device as claimed in claim 1, wherein
the encoding unit encodes the image data while periodically changing the color component to be encoded in the order of Y component, UV component, Y component, UV component per frame.

5. The image transmission device as claimed in claim 1, further comprising a division pattern setting unit for setting a color component division pattern indicating setting of change of the color component to be encoded, wherein
the encoding unit selects the color component to be encoded from the plurality of color components while periodically changing the color component to be encoded in accordance with the color component division pattern set by the division pattern setting unit and then encodes the image data of the selected color component to be encoded, and
the data transfer unit appends the color component division pattern set by the division pattern setting unit to the encoded image data of the selected color component to be encoded and transfers the resulting encoded image data to the data communication line.

6. The image transmission device as claimed in claim 5, wherein
the data transfer unit measures a communication load of the data communication line, and
the division pattern setting unit sets the color component division pattern depending on the communication load measured by the data transfer unit.

7. The image transmission device as claimed in claim 1, further comprising a motion detecting unit for detecting a quantity of image motion in the inputted image data, wherein
the encoding unit encodes all of the color components constituting the image data when the encoding unit determines that the quantity of image motion detected by the motion detecting unit is greater than a given threshold value.

8. The image transmission device as claimed in claim 1, further comprising a motion detecting unit for detecting a quantity of image motion in the inputted image data, wherein
the encoding unit changes the color component to be encoded per frame,
the motion detecting unit detects a quantity of motion of a color component different to the color component to be encoded, and
the data transfer unit further transfers the quantity of motion of the color component different to the color component to be encoded to the data communication line.

9. The image reception device as claimed in claim 2, further comprising a motion compensating unit, a smoothening unit, and a combining unit, wherein
the data receiving unit further receives a quantity of motion of a color component different to the color component to be encoded,
the motion compensating unit performs a motion compensation to the past image data stored in the storage unit using the quantity of motion of the color component newly received,
the smoothening unit smoothens the past image data stored in the storage unit and the image data of the color component to be encoded newly received and decoded by the decoding unit depending on the quantity of motion of the color component newly received, and
the combining unit combines the image data of the color component to be encoded newly received by the data receiving unit and smoothened by the smoothening unit and then decoded by the decoding unit with the past image data motion-compensated by the motion compensating unit.
